(19) United States
(12) Patent Application Publication
(10) Pub. No.: US 2009/0089255 A1
(43) Pub. Date: Apr. 2, 2009

(54) INFORMATION SEARCH APPARATUS AND METHOD

(75) Inventors: Eui-Heon JEONG, Suwon-si (KR); Yeong-Geol KIM, Yongin-si (KR); So-Jin KIM, Suwon-si (KR); Seung-Yeol YOO, Suwon-si (KR); Bok-Yeon LEE, Suwon-si (KR); Jin-Ho CHOI, Seoul (KR); Ho-Sang KIM, Suwon-si (KR); Seung-Hyun KIM, Anyang-si (KR); Seung-Jae LEE, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/044,137

(22) Filed: Mar. 7, 2008

(30) Foreign Application Priority Data
Sep. 27, 2007 (KR) 10-2007-0097466

(51) Int. Cl. G06F 17/30

(52) U.S. Cl. 707/3; 707/E17.014

(57) ABSTRACT

Provided is an information search apparatus and method. The method includes extracting first information and second information from specific information that is received; determining whether the second information satisfies specific conditions; generating a query by combining the second information and the first information if it is determined that the second information satisfies the specific conditions; and transmitting the generated query to a terminal.

### CROSS-REFERENCE TO RELATED APPLICATION

This application claims priority from Korean Patent Application No. 10-2007-0097466 filed on Sep. 27, 2007 in the Korean Intellectual Property Office, the disclosure of which is incorporated herein by reference in its entirety.

### BACKGROUND OF THE INVENTION

1. Field of the Invention

Apparatuses and methods consistent with the present invention relate to information search, and more particularly, to providing optimal search results to users according to their preferences and situations and providing useful information to information providers and advertisers.

2. Description of the Related Art

As the amount of information available on the Internet becomes vast—in particular, as the type and number of Internet advertisements increases and customers' preferences become more diverse—the importance of personalized advertisements for specific customers or customized advertisements for specific events is growing. As such, a system of implementing a number of sensors, which can sense surrounding conditions including temperature and weather, in mobile terminals such as global positioning system (GPS) receivers has been developed to provide information to users according to constantly changing environmental conditions and the users' preferences.

FIG. 1 illustrates a related art situation-based search system. Referring to FIG. 1, a terminal 10 may include a location determination module (not shown) that recognizes location information of the terminal 10. Using the location determination module, the terminal 10 may provide its location information via wireless network to a server 20. If the terminal 10 requests the server 20 to search for data based on the location information, the server 20 searches data stored in a database 30 and provides the searched data to the terminal 10 via wireless network.

The related art described above classifies customer needs according to their locations and unique interests. However, it does not specify a query structure or an applicable search model required to provide useful and optimal information to users.

In addition, the related art situation-based search system focuses only on users' needs. Even if the system benefits information providers, it falls short of solving the scalability problem caused by the rapidly increasing amount of information being provided.

### SUMMARY OF THE INVENTION

Exemplary embodiments of the present invention overcome the above-described disadvantages and other disadvantages not described above. Also, the present invention is not required to overcome the disadvantages described above, and an exemplary embodiment of the present invention may not overcome any of the problems described above.

The present invention provides an information search apparatus and method which can extract first information and second information from specific information that is received, generate a query by combining the first information and the second information if the extracted second information satisfies specific conditions, and transmit the generated query to a terminal.

According to an aspect of the present invention, there is provided an information search method including: extracting first information and second information from specific information that is received; identifying whether the second information satisfies specific conditions; generating a query by combining the second information and the first information if the second information satisfies the specific conditions, and transmitting the generated query to a terminal.

According to another aspect of the present invention, there is provided an information search method including: generating customer information and dynamic response information; identifying whether a query received from a customer search apparatus satisfies the customer information and the dynamic response information; and generating a response signal corresponding to the query if the query satisfies the customer information and the dynamic response information.

According to another aspect of the present invention, there is provided an information search apparatus including: an extraction module which extracts first information and second information from specific information that is received; a sensor module which measures specific conditions corresponding to the second information; a determination module which identifies whether the second information satisfies the specific conditions; and a generation module which generates a query by combining the second information and the first information if the second information satisfies the specific conditions, wherein the generated query is transmitted to a receiving apparatus.

According to another aspect of the present invention, there is provided a receiving apparatus including: a storage module which stores user information that includes customer information and dynamic response information; a determination module which identifies whether a query received from an information search apparatus satisfies the customer information and the dynamic response information; and a generation module which generates a response signal corresponding to the query if the query satisfies the customer information and the dynamic response information.

### BRIEF DESCRIPTION OF THE DRAWINGS

The above and other aspects of the present invention will become more apparent by describing in detail exemplary embodiments thereof with reference to the attached drawings, in which:

FIG. 1 illustrates a related art situation-based search system;

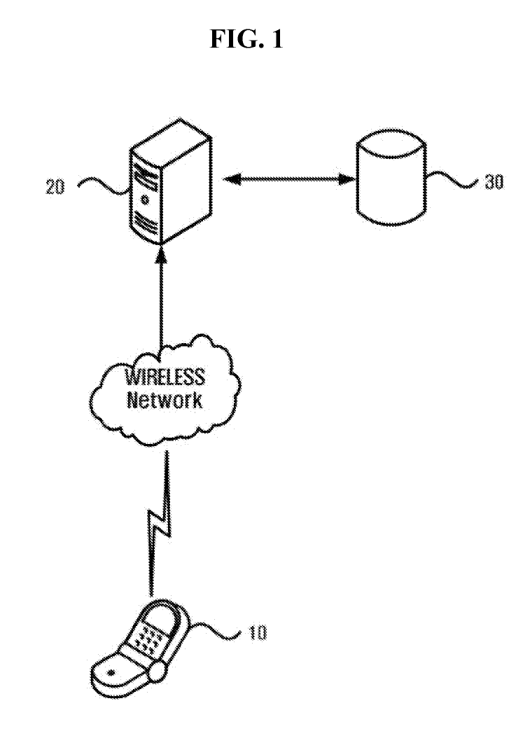

FIG. 2 is a block diagram of an information search system including a customer search apparatus and an information search apparatus as separate apparatuses, according to an exemplary embodiment of the present invention;

FIG. 3 is a block diagram of the customer search apparatus of the information search system of FIG. 2;

FIG. 4 is a block diagram of a receiving apparatus of the information search system of FIG. 2;

FIG. 5 is a flowchart illustrating an information search method according to an exemplary embodiment of the present invention;

FIG. 6 illustrates a customer search process of the information search method of FIG. 5; and

FIG. 7 illustrates a customer segmentation process of the information search method of FIG. 5.

### DETAILED DESCRIPTION OF THE EXEMPLARY EMBODIMENTS

The various aspects and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the present invention to those skilled in the art, and the present invention is defined by the appended claims. Like reference numerals refer to like elements throughout the specification.

Hereinafter, a plug and install system and method according to exemplary embodiments of the present invention will be described with reference to block diagrams or flowchart illustrations. The term ‘module’ as used herein means, but is not limited to, a software or hardware component, such as a Field Programmable Gate-Array (FPGA) or Application-Specific Integrated Circuit (ASIC), which performs certain tasks. A module may advantageously be configured to reside on the addressable storage medium and additionally be configured to execute on one or more processors. Thus, a module may include, by way of example, components such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules of the exemplary embodiments may be combined into fewer components and modules or further separated into additional components and modules.

Hereinafter, exemplary embodiments of the present invention will be described in detail with reference to the attached drawings.

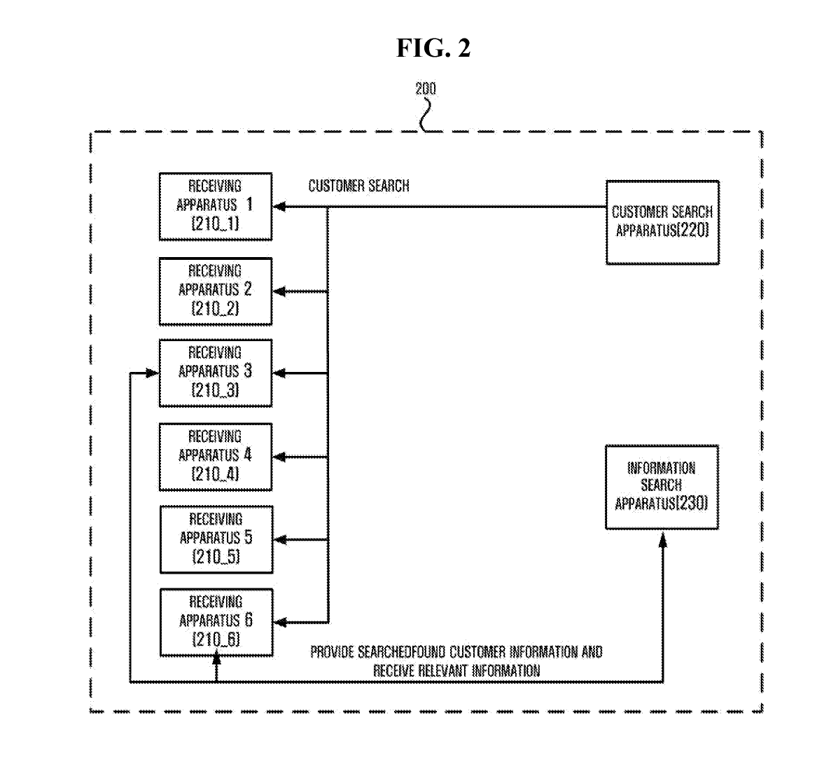

FIG. 2 is a block diagram of an information search system 200 including a customer search apparatus 220 and an information search apparatus 230 as separate apparatuses, according to an exemplary embodiment of the present invention.

Referring to FIG. 2, the information search system 200 includes receiving apparatuses 210_1 through 210_6, the customer search apparatus 220, and the information search apparatus 230.

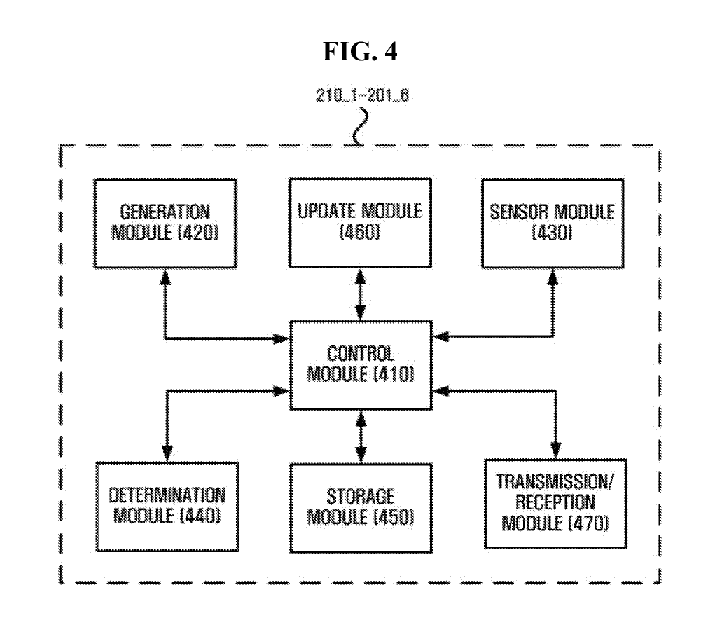

Each of the receiving apparatuses 210_1 through 210_6 includes a control module 410, a generation module 420, a sensor module 430, a determination module 440, a storage module 450, an update module 460, and a transmission/reception module 470, as illustrated in FIG. 4. The receiving apparatuses 210_1 through 210_6 will be described in detail later with reference to FIG. 4.

According to an exemplary embodiment of the present invention, the receiving apparatuses 210_1 through 210_6 may be provided in computers, personal digital assistants, portable multimedia players, mobile phones, and the like.

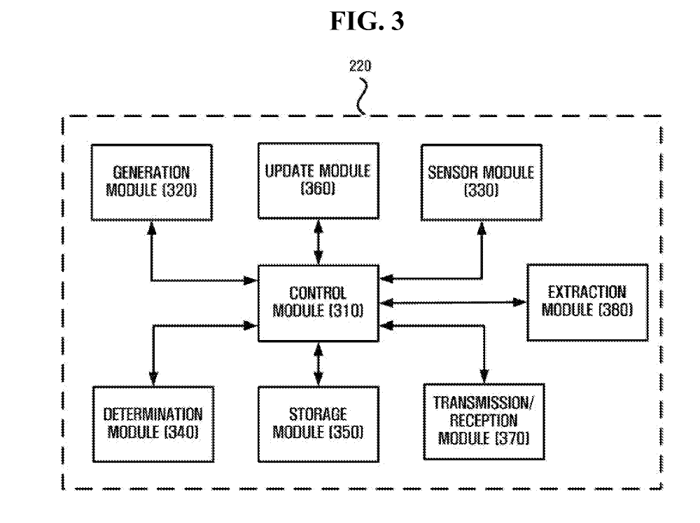

The customer search apparatus 220 includes a control module 310, a generation module 320, a sensor module 330, a determination module 340, a storage module 350, an update module 360, a transmission/reception module 370, and an extraction module 380, as illustrated in FIG. 3. The customer search apparatus 220 will be described in detail later with reference to FIG. 3.

The information search apparatus 230 receives a response signal from any one of the receiving apparatuses 210_1 through 210_6, searches for information corresponding to the response signal, and generates response information. According to an exemplary embodiment of the present invention, an information search module (not shown) may be provided in the customer search apparatus 220.

In addition, according to an exemplary embodiment of the present invention, the customer search apparatus 220 and the information search apparatus 230 may be configured independently.

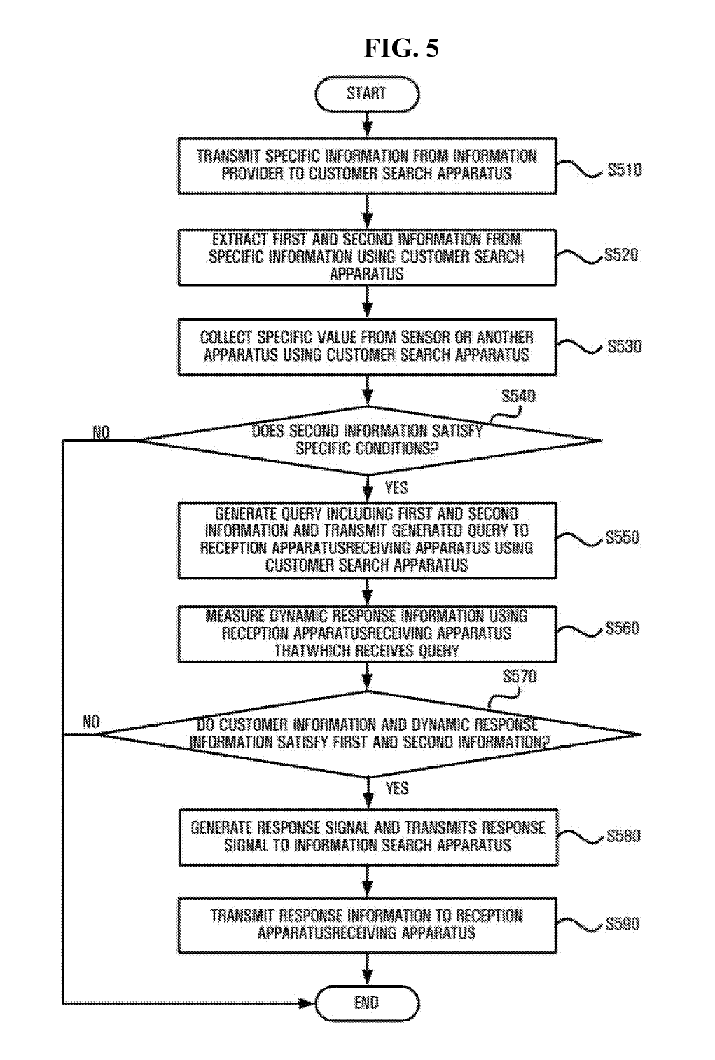

Using the information search system 200, an information provider, such as an advertisement agent, generates information required to search for target customers and transmits the generated information to the customer search apparatus 220. When receiving the generated information, the customer search apparatus 220 extracts specific conditions, combines the extracted conditions with the received information, and generates a query. If the customer search apparatus 220 transmits the query to the receiving apparatuses 210_1 through 210_6, the receiving apparatuses 210_1 through 210_6 compare previously generated requirements to the query, and request the information search apparatus 230 to search information. Then, the information search apparatus 230 searches the information and transmits the searched information to the receiving apparatuses 210_1 through 210_6. The above process will be described in detail later with reference to FIGS. 5, 6, 7, and 8.

FIG. 3 is a block diagram of the customer search apparatus 220 of the information search system 200 of FIG. 2.

Referring to FIG. 3, the customer search apparatus 220 includes the control module 310, the generation module 320, the sensor module 330, the determination module 340, the storage module 350, the update module 360, the transmission/reception module 370, and the extraction module 380.

The transmission/reception module 370 receives specific information from an information provider. The specific information may include first information and second information. The first information may include static information, and the static information may include age, gender, birth date, name, and the like requested by the information provider. That is, the static information includes information that rarely varies with time or place. The static information is an important factor to consider when the information provider determines the desired target customers.

The second information may include dynamic information, and the dynamic information may include temperature, weather, and the like. That is, the dynamic information includes information that frequently varies with time or place. In addition, the dynamic information may be set to a predetermined range. For example, temperature may be set to a range of “20 to 30° C.” The dynamic information is an important factor to consider when the information provider determines the desired target customers.

The transmission/reception module 370 transmits and receives data using the Internet or wireless Internet. In this case, the data may include a query generated by the customer search apparatus 220 and the specific information.

The specific information received by the transmission/reception module 370 may be transmitted to the extraction module 380 via the control module 310 or may be transmitted directly to the extraction module 380.

When receiving the specific information from the transmission/reception module 370, the extraction module 380 extracts the first information and the second information from the specific information. As described above, the first information includes the static information, and the second information includes the dynamic information.

The sensor module 330 measures the dynamic information corresponding to the second information by using a predetermined sensor. Alternatively, the sensor module 330 may sense and collect the dynamic information corresponding to the second information from another terminal or apparatus which measures and stores current dynamic information. Accordingly, specific conditions, which include the current dynamic information corresponding to the second information, are generated and then transmitted to the determination module 340.

When receiving the extracted first information, the extracted second information, and the specific conditions collected by the sensor module 330, the determination module 340 may determine whether the second information satisfies the specific conditions. According to an exemplary embodiment of the present invention, the determination module 340 may determine whether customer information, which corresponds to the first information and was previously received from customers, is stored in the storage module 350 and whether the first information satisfies the customer information. In addition, according to an exemplary embodiment of the present invention, the determination module 340 may compare the second information to the specific conditions and the first information to the customer information and determine whether the first information and the second information satisfy the specific conditions and the customer information, respectively.

As described above, if the first information and/or the second information satisfy the specific conditions and the customer information, the first and second information is transmitted to the generation module 320.

The generation module 320 converts the first and second information into a predetermined format, generates a query, and transmits the generated query to the receiving apparatuses 210_1 through 210_6 via the transmission/reception module 370.

According to an exemplary embodiment of the present invention, the query may be transmitted to some of the receiving apparatuses 210_1 through 210_6 of target customers who satisfy the first and second information. According to an exemplary embodiment of the present invention, the query may be transmitted to target customers who satisfy only the first information or target customers who satisfy only the second information. In addition, according to an exemplary embodiment of the present invention, the query may be transmitted to all customers stored in the customer search apparatus 220, and the customers may determine whether the query is useful information.

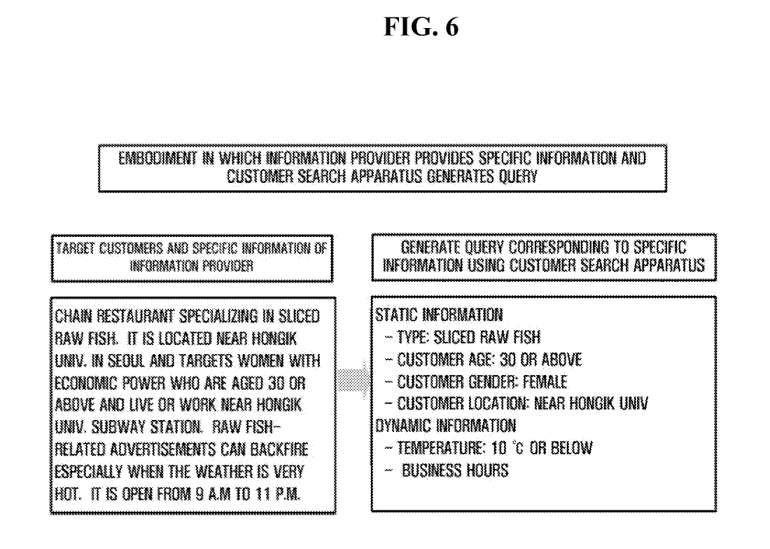

The predetermined format described above is illustrated in FIG. 6. However, the present invention is not limited thereto.

When the update module 360 receives the first information, the second information, the customer information or the response information from an information provider or a customer, it updates the storage module 350 in the customer search apparatus 220 according to the received information.

The storage module 350 stores the first information and the second information provided by the information provider and stores the specific conditions received from the sensor module 330 or other apparatuses. In addition, the storage module 350 may store the customer information and store information updated by the update module 360.

The control module 310 manages and controls all modules within the customer search apparatus 220.

FIG. 4 is a block diagram of one of the receiving apparatuses 210_1 through 210_6 of the information search system 220 of FIG. 2.

Referring to FIG. 4, the receiving apparatus may include the control module 410, the generation module 420, the sensor module 430, the determination module 440, the storage module 450, the update module 460, and the transmission/reception module 470.

The transmission/reception module 470 receives a query and response information, and transmits a response signal.

As described above, the sensor module 430 measures the temperature, weather and location of a place where it is disposed, generates dynamic response information corresponding to the second information, and transmits the dynamic response information to the control module 410, the determination module 440, or the storage module 450.

The storage module 470 stores customer information and the dynamic response information generated by the sensor module 430.

The determination module 440 receives first information and second information included in the query, the customer information and the dynamic response information, and determines whether the first information and the second information satisfy the customer information and the response information. If the first information and the second information satisfy the customer information and the dynamic response information, the determination module 440 transmits the customer information and the dynamic response information to the generation module 420.

The generation module 420 generates a response signal including the customer information and the dynamic response information and transmits the generated response signal to the information search apparatus 230 via the transmission/reception module 470.

When the customer information and the dynamic response information are updated, the update module 460 stores the updated customer information and dynamic response information in the storage module 450 and transmits the updated customer information and dynamic response information to the customer search apparatus 220 via the transmission/reception module 470.

The control module 410 manages and controls all modules in the receiving apparatus.

FIG. 5 is a flowchart illustrating an information search method according to an exemplary embodiment of the present invention.

Referring to FIG. 5, an information provider transmits specific information to the customer search apparatus 220 (operation S510).

FIG. 6 illustrates a customer search process of the information search method of FIG. 5. Referring to FIG. 6, an information provider generates specific information in order to find desired target customers and transmits the specific information to the customer search apparatus 220. As described above, the specific information may include ages and preferences of the target customers, time, weather, and the like.

The customer search apparatus 220 receives the specific information and extracts first information and second information from the specific information (operation S520). As described above, the specific information includes static information, which rarely changes, such as ages and preferences of target customers, and the static information is defined as the first information. In addition, the specific information includes dynamic information, such as time, weather and temperature, which varies. The dynamic information is defined as the second information.

Referring back to FIG. 5, after the customer search apparatus 220 extracts the first information and the second information, it collects specific conditions from a sensor or another apparatus (operation S530). The specific conditions are values corresponding to the second information and may include current temperature, weather and position. The specific conditions may be measured using a sensor included in the customer search apparatus 220. Alternatively, according to an exemplary embodiment of the present invention, the specific conditions may be received from an apparatus storing current temperature, weather and position.

If the specific conditions are received, it is determined whether the second information satisfies the specific conditions (operation S540). According to an exemplary embodiment of the present invention, whether the first information and the second information respectively satisfy the customer information and the specific conditions are determined.

If the second information satisfies the specific conditions, the customer search apparatus 220 generates a query including the first information and the second information and transmits the query to the receiving apparatuses 210_1 through 210_6, using the customer search apparatus 220 (operation S550).

Referring back to FIG. 6, the specific information provided by the information provider is divided into the static information (the first information) and dynamic information (the second information), and a query is generated.

When receiving the query, the receiving apparatuses 210_1 through 210_6 measure dynamic response information (operation S560). Using the sensor module 430 installed therein, the receiving apparatuses 210_1 through 210_6 measure the dynamic response information, such as current location and current temperature.

After the dynamic response information is measured, it is determined whether the customer information and the dynamic response information respectively satisfy the first information and the second information (operation S570). The customer information corresponds to the first information and is stored in the receiving apparatus 210_1 through 210_6 according to customer needs.

When the customer information and the dynamic response information satisfy the first information and the second information, the receiving apparatuses 210_1 through 210_6 generate response signals and transmit the response signals to the information search apparatus 230 (operation S580).

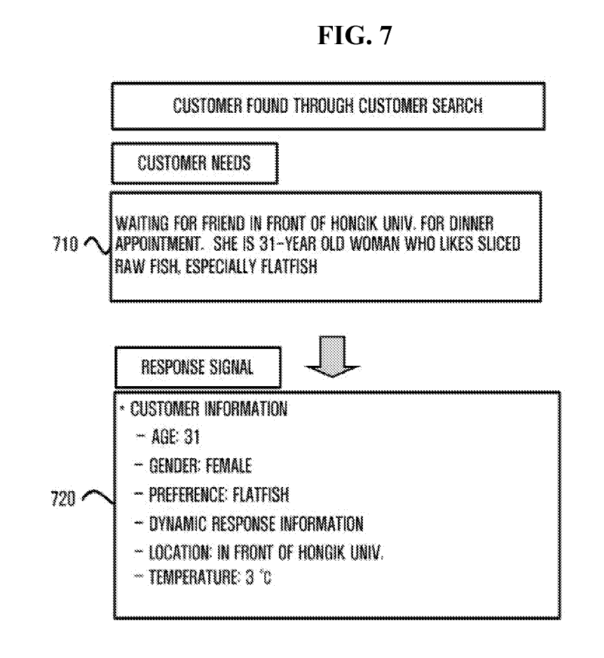

FIG. 7 illustrates a customer segmentation process of the information search method of FIG. 5. Referring to FIG. 7, customer needs 710 and a response signal 720 are provided. The response signal 720 includes customer information and dynamic response information.

If the response signal 720 is generated and transmitted to the information search apparatus 230 (operation S580), the information search apparatus 230 searches first information and second information corresponding to the customer information and the dynamic response information, and generates response information.

Referring back to FIG. 5, after generating the response information, the information search apparatus 230 transmits the generated response information to the receiving apparatuses 210_1 through 210_6 (operation S590). Here, customers may receive the response information according to the priority of their respective needs and obtain desired information.

According to an exemplary embodiment of the present invention, the receiving apparatuses 210_1 through 210_6 and the information search apparatus 220 may update the first information, the second information, the customer information and the dynamic response information, using the response signals and the response information.

As described above, an information search apparatus and method according to the present invention can provide useful and suitable information to both information providers and users.

In addition, according to the present invention, unlike the conventional systems which have limits in their search capabilities as the amount of information or the number of users is increased, the information search apparatus and method are scalable for a small number of target customers.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. An information search method comprising:
extracting first information and second information from specific information that is received;
determining whether the second information satisfies specific conditions;
generating a query by combining the second information and the first information if it is determined that the second information satisfies the specific conditions; and
transmitting the generated query to a terminal.

2. The method of claim 1, wherein the specific information is generated by and received from an information provider.

3. The method of claim 1, wherein the first information comprises static information which comprises customer information, and the second information includes dynamic information which comprises at least one of temperature and weather.

4. The method of claim 1, further comprising measuring at least one of current temperature and weather after the extracting the first information and the second information, wherein the at least one of temperature and weather is designated as the specific conditions.

5. The method of claim 1, further comprising searching for response information corresponding to a response signal if the response signal is received from the terminal, wherein the searched response information is transmitted to the terminal.

6. The method of claim 5, wherein the response signal comprises at least one of customer information and dynamic response information, wherein the customer information comprises static information, and the dynamic response information comprises at least one of location information, temperature information and weather information of a current position.

7. The method of claim 5, further comprising updating the first information and the second information in response to the response signal.

8. An information search method comprising:
generating customer information and dynamic response information;
determining whether a query received from a customer search apparatus satisfies the customer information and the dynamic response information; and
generating a response signal corresponding to the query if it is determined that the query satisfies the customer information and the dynamic response information.

9. The method of claim 8, wherein the customer information comprises static information, and the dynamic response information comprises at least one of location information, temperature information and weather information of a current position.

10. The method of claim 8, further comprising:
receiving response information corresponding to the response signal; and
updating the customer information based on the response information.

11. An information search apparatus comprising:
an extraction module which extracts first information and second information from specific information that is received;
a sensor module which measures specific conditions corresponding to the second information;
a determination module which determines whether the second information satisfies the specific conditions;
a generation module which generates a query by combining the second information and the first information if the determination module determines that the second information satisfies the specific conditions; and
a transmission module which transmits the generated query to a receiving apparatus.

12. The apparatus of claim 11, wherein the specific information is generated by and received from an information provider.

13. The apparatus of claim 11, wherein the first information includes static information which comprises customer information, and the second information includes dynamic information which comprises at least one of temperature and weather.

14. The apparatus of claim 11, wherein the sensor module measures at least one of location information, temperature information and weather information of a current position.

15. The apparatus of claim 11, further comprising a search module which searches response information corresponding to a response signal if the response signal is received from the receiving apparatus, wherein the searched response information is transmitted to the receiving apparatus.

16. The apparatus of claim 11, wherein the response signal comprises at least one of customer information and dynamic response information, wherein the customer information comprises static information, and the dynamic response information comprises at least one of location information, temperature information and weather information of a current position.

17. The apparatus of claim 15, further comprising an update module which updates the first information and the second information in response to the response signal.

18. A receiving apparatus comprising:
a storage module in which user information is stored, the user information comprising customer information and dynamic response information;
a determination module which determines whether a query received from an information search apparatus satisfies the customer information and the dynamic response information; and
a generation module which generates a response signal corresponding to the query if the determination module determines that the query satisfies the customer information and the dynamic response information.

19. The apparatus of claim 18, wherein the customer information comprises static information, and the dynamic response information comprises at least one of location information, temperature information and weather information of a current position.

20. The apparatus of claim 18, further comprising:
a reception module which receives response information corresponding to the response signal; and
an update module which updates the user information based on the response information.
